(19) United States
(12) Patent Application Publication
(10) Pub. No.: US 2022/0121977 A1
(43) Pub. Date: Apr. 21, 2022

(54) MATRIX-BASED PATTERN PREDICTION OF SEMI-CHAOTIC SYSTEMS

(71) Applicant: Acorient Scientific Research & Development, LLC, Cartersville, GA (US)

(72) Inventor: Gary Dale Sullivan, Arvada, CO (US)

(73) Assignee: Acorient Scientific Research & Development, LLC, Cartersville, GA (US)

(21) Appl. No.: 17/074,041

(22) Filed: Oct. 19, 2020

(51) Int. Cl. G06N 7/08

(52) U.S. Cl. CPC G06N 7/08

(57) ABSTRACT

A matrix-based pattern prediction system of the present disclosure is that of a multi-block matrix-based system that operates on an input signal having a time-based pattern that is semi-chaotic. The system includes a wavelet/time conversion block Mλ, which is representative of a wavelet transformation of a semi-chaotic input signal, and a memory block MP which stores the wavelet coefficients generated by Mλ in an asymmetric matrix. The system further includes a predictor block MPP, which performs a time shifted symbolic operation on the memory block MP and is, therefore representative of the time shifted wavelet (Mλ). A Pattern Output block transforms the output predictor block MPP into a time-based output that is predictive of the semi-chaotic time-based input at a future point in time. First and second variables (Cp and Cpp) are automatically generated and used to compensate low (Cp) and high (Cpp) frequency components of an input.

### TECHNICAL FIELD

The present disclosure is directed to pattern prediction and, more particularly to a matrix-based pattern prediction of semi-chaotic systems.

### BACKGROUND

The ability to predict the future operation of a semi-chaotic system could help to ensure that the operation of the system is continuous, stable and/or efficient. For instance, consider the example of a pressurized pumping system that is subject to line pressure fluctuations. The ability to predict where, when and/or how line pressure fluctuations might occur enable the implementation of system modifications such that the line pressure fluctuations are reduced or even eliminated. In another example, the ability to anticipate a quantity of goods that will be needed at a future point in time might be used to assist in purchasing and/or stockpiling an appropriate amount of raw materials needed to produce the anticipated quantity and, thereby, reduce or eliminate slow-downs in the manufacture of the goods. It is with the above-described needs in mind, that the instant disclosure is presented.

### SUMMARY

Matrix-based pattern prediction of semi-chaotic systems, according to the present disclosure, is suitable for use in any number of pattern prediction systems. The matrix-based pattern prediction anticipates the value of a process input thereby enabling compensation of the process input to produce a desired output.

An aspect of the present disclosure is directed to a system for predicting an output pattern based on a semi-chaotic time-based input. The system includes a matrix-based wavelet conversion block, a matrix-based memory block, a matrix-based predictor block and a matrix-based pattern output block. The matrix-based wavelet conversion block receives the semi-chaotic time-based input and transforms the input into a plurality of wavelets. Each of the plurality of wavelets is associated with a coefficient that is representative of time and frequency. The coefficients are mapped to a first asymmetric matrix having first and second axes (e.g., tλ, tp). Note: The names of the axes (tλ, tp).are provided for reference only and are not limiting, rather any appropriate and/or desired label may be applied to the axes. The matrix-based memory block maps the coefficients of the first asymmetric matrix to a second asymmetrix matrix having flipped first and second axes (e.g., tλ, tp). The matrix-based predictor block maps the coefficients of the second asymmetric matrix to a third asymmetric matrix in a time-shifted configuration. The amount of time-shifting can be predetermined or can be variable in accordance with a closed loop analysis. The matrix-based pattern output block transforms the coefficients of the third asymmetric matrix into a time-based output pattern that is predictive of the semi-chaotic based-input at future time.

Another aspect of the present disclosure is directed to a method for predicting an output pattern based on a semi-chaotic time-based input. The method includes transforming the semi-chaotic time-based input into a plurality of wavelets, each of the plurality of wavelets associated with a coefficient and mapping the coefficients of the plurality of wavelets to a first asymmetric matrix having a first axis (tλ) and a second axis (tp). The method further includes mapping the coefficients of the plurality of wavelets to a second asymmetric matrix having a first axis (tλ) and a second axis (tp), wherein two 360° matrices and a zero degree matrix are used to effect the mapping. The method further includes mapping the coefficients of the second asymmetric matrix to a third asymmetric matrix having a first axis (tp) and a second axis (tλ), wherein two 360° matrices and a zero degree matrix are used to effect the mapping in conjunction with a time-shift. The method also includes transforming the time-shifted coefficients into a time-based output pattern that is a predictive of the semi-chaotic time-based input at a future time.

### BRIEF DESCRIPTION OF THE DRAWINGS

FIG. 1A is a depiction of a two-dimensional symmetric matrix that can be used to implement an aspect of the matrix-based pattern prediction system.

FIG. 1B is a depiction of a three-dimensional symmetric matrix that can be used to implement an aspect of the matrix-based pattern prediction system.

FIGS. 2A-2C are depictions of a symmetric matrix having a major axis at 360 degrees, zero degrees and 180 degrees, respectively.

FIG. 3A-3B are examples of the symmetric matrices: M360 & Mzero based on the Major Axis and an asymmetric matrix Mλ utilized by the pattern prediction system of the present disclosure.

FIG. 4 is a depiction of a simplified schematic of the matrix-based pattern prediction system of the present disclosure

FIG. 5 is a depiction of notation representative of the operation of the matrix-based wavelet transform block utilized by the matrix-based pattern prediction system.

FIG. 6 is a depiction of notation representative of the operation of the matrix-based memory block, MP, utilized by the matrix-based pattern prediction system.

FIG. 7 is a depiction of notation representative of the operation of the matrix-based predictor block, MPP, utilized by the matrix-based pattern prediction system.

FIG. 8 provides a combination depiction of notation representative of the operation of the matrix-based memory block, MP, (also see FIG. 6) and matrix-based predictor block, MPP, (also see FIG. 7) to more clearly illustrate the flow of operations from block to block.

FIG. 9 is a depiction of notation representative of the operation of the matrix-based output block, Pattern Output utilized by the matrix-based pattern prediction system.

FIG. 10 is a depiction of a comparison plot comparing a known input to the matrix-based pattern prediction system and an output predicted by the matrix-based pattern prediction system with the inputted pattern ending at time tp and the pattern to be predicted beginning at time tp. The inputted pattern ends at time “255”, the pattern to be predicted begins at time “255”.

FIG. 11 is a depiction of an exemplary time-based, semi-chaotic pattern input to the matrix-based pattern prediction system comparing the input to an output predicted by the matrix-based pattern prediction system. The inputted pattern ends at time “1023”, the pattern to be predicted begins at time “1023”. The remainder of the inputted pattern after time “1023” is not inputted into the matrix-based pattern prediction system but is shown for comparison of the prediction to the predicted pattern.

FIG. 12 is a depiction of another exemplary time-based, semi-chaotic pattern input to the matrix-based pattern prediction system comparing the input to an output predicted by the matrix-based pattern prediction system. The inputted pattern ends at time “1023”, the pattern to be predicted begins at time “1023”. The remainder of the inputted pattern after time “1023” is not inputted into the matrix-based pattern prediction system but is shown for comparison of the prediction to the predicted pattern.

FIG. 13 is a depiction of another exemplary time-based, semi-chaotic pattern input to the matrix-based pattern prediction system comparing the input to an output predicted by the matrix-based pattern prediction system. The inputted pattern ends at time “1023”, the pattern to be predicted begins at time “1023”. The remainder of the inputted pattern after time “1023” is not inputted into the matrix-based pattern prediction system but is shown for comparison of the prediction to the predicted pattern.

FIG. 14 is a depiction of another exemplary time-based, semi-chaotic pattern input to the matrix-based pattern prediction system comparing the input to an output predicted by the matrix-based pattern prediction system. The inputted pattern ends at time “1023”, the pattern to be predicted begins at time “1023”. The remainder of the inputted pattern after time “1023” is not inputted into the matrix-based pattern prediction system but is shown for comparison of the prediction to the predicted pattern.

### DETAILED DESCRIPTION

A matrix-based pattern prediction system of the present disclosure is that of a multi-block matrix-based system that operates on an input signal having a time-based pattern that is semi-chaotic. The system includes a wavelet/time conversion block Mλ, which is representative of a wavelet transformation of a semi-chaotic input signal, and a memory block MP which stores the wavelet coefficients generated by Mλ in an asymmetric matrix. The system further includes a predictor block MPP, which performs a time shifted symbolic operation on the memory block MP and is, therefore representative of the time shifted wavelet (Mλ). A Pattern Output block transforms the output of the predictor block MPP into a time-based output that is predictive of the semi-chaotic time-based input at a future point in time. In certain embodiments, first and second variables (Cp and Cpp) are used to compensate low (Cp) and high (Cpp) frequency components of an inputted semi-chaotic pattern. More specifically, the two variables Cp and Cpp are used to compensate for frequency (time delay) components that are outside the matrix time delay (frequency) range of the matrices of the matrix-based pattern prediction system. Within the frequency domain, the matrix-based pattern prediction system can be described as a bandpass filter.

One skilled in the art will understand that the matrix-based pattern prediction system discussed herein is susceptible of embodiments in any digital system architecture. For example, the matrix-based pattern prediction system presented herein may be embodied as software or firmware stored in a non-transitory memory device and used to program a processing unit. Alternatively, the matrix-based pattern prediction system may be embodied as a set of logic gates and associated circuitry making up an application-specific integrated circuit (ASIC). Still further, the matrix-based pattern prediction system may be embodied by one or more programmable gate arrays cooperating to implement the embodiments presented herein. Any combination of the described digital system architectures may be alternatively and/or additionally used to implement the embodiments of the matrix-based pattern prediction system described herein.

Matrix-based systems are based on time. Specifically, time delays inherent in the cells of a matrix-based system with each cell having an intrinsic time delay “Tc”. The total time delay of each matrix being N*Tc=Tm, where “N” is the axis (matrix) size.

A matrix-based system such as the matrix-based pattern prediction system, when considered in the frequency domain, operates as a band pass filter and can be described as:

Tc≤Tp≤N*Tm Eq. (1)
Where:
Tc=time delay of each cell in a symmetrical matrix
Tm=time delay of a symmetrical matrix
N=matrix size
Tp=is the RANGE of time delays (frequency's) inherent in the inputted pattern

Expressed in the frequency domain this becomes, when expressed as λd=1/Td:

1/λc≤1/λp≤N/λm Eq. (2)
Where:
λc=the range of frequency's not greater than λp
λp=the range of frequency's inherent in the pattern to be predicted
N/λm=the range of frequencys' not less than λp

What this implies is that if the pattern time delay is less than the time delay of a matrix cell, the cell cannot change fast enough to track that frequency component. If the pattern time delay is greater than the time delay of the matrix, it is seen as a DC component.

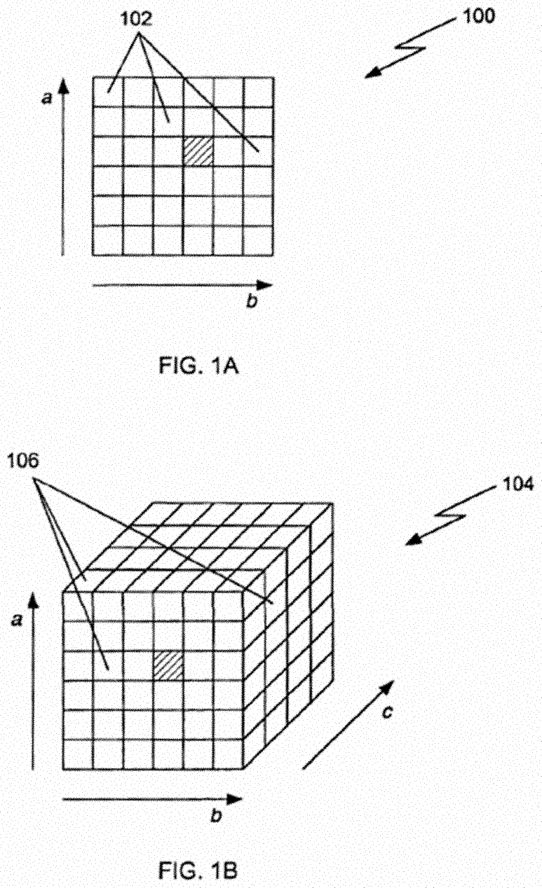

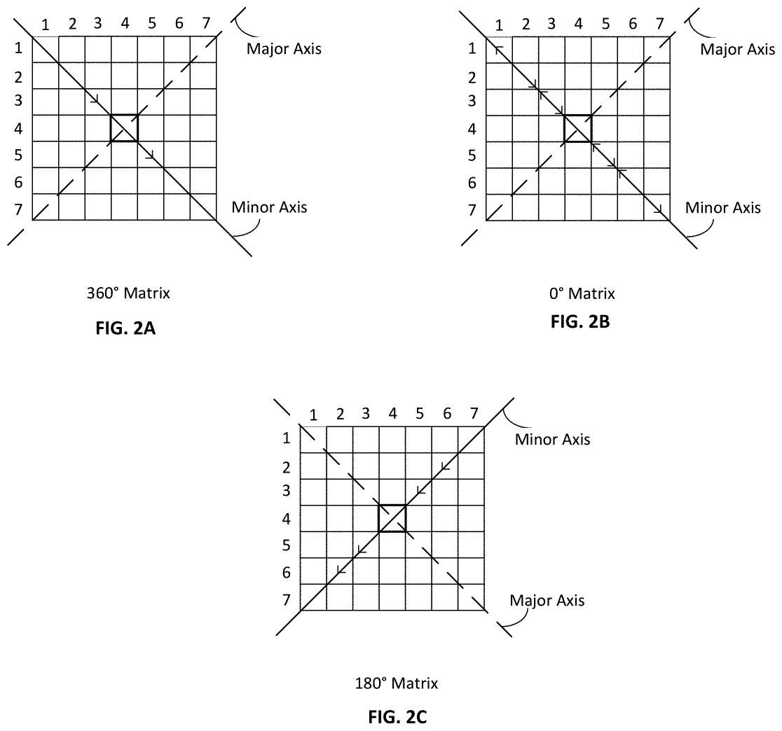

In further aid of better understanding of the present disclosure, a brief explanation of matrices and matrix notation is provided. The matrix-based pattern prediction system utilizes symmetric matrices, examples of which are illustrated in FIGS. 1A-1B and 2A-2C. FIG. 1A illustrates a two-dimensional, two-axis matrix 100 with axes A and B. FIG. 1B illustrates a three-axis matrix 104 with axes A, B and C.

FIGS. 2A-2C illustrate a symbolic matrix in its three primary configurations 360°, zero° and 180° configurations, e.g., Rm=360°, Rm=0°, and Rm=180°, where Rm, in degrees, comprises the three possible ways the major axis can be rotated; a complete rotation of the matrix occurs at Rm=360°. It should be noted that the bolded center block of each matrix in FIGS. 2A-2C marks the center pivot cell of the symmetric matrix. Further, it should be noted that for N=255 the content of the center pivot cell is 128 (e.g., (255+1)/2=128), where N is the number of symbols on a symmetric axis.

In the context of the matrix-based pattern prediction system of the present disclosure, the zero degree matrix has zero forcing action, in that the forcing action cancels itself out internally in the matrix so that a pattern passes untouched in a zero degree matrix. This zero degree matrix is used to provide an equal mapping path in the pattern prediction system, described in further detail below. The 180 degree matrix of FIG. 2C and the 360 degree matrix of FIG. 2A provide the maximum forcing action upon a pattern to form a closed mapping path using both axes. The ability to close a mapping path in the pattern prediction system of the present disclosure is based on the forcing action inherent in a symbolic matrix. The inherent forcing action (Cm) can be described as:

Cm=cos(Rm) Eq. (3)
Where:
Rm=rotation of the major axis of the symbolic matrix in degrees.

Accordingly, for the zero matrix, Rm=0 deg and Cm=1; for the 180 degree matrix, Rm=180 and Cm=−1; and for the 360 degree matrix, Rm=360 and Cm=1).

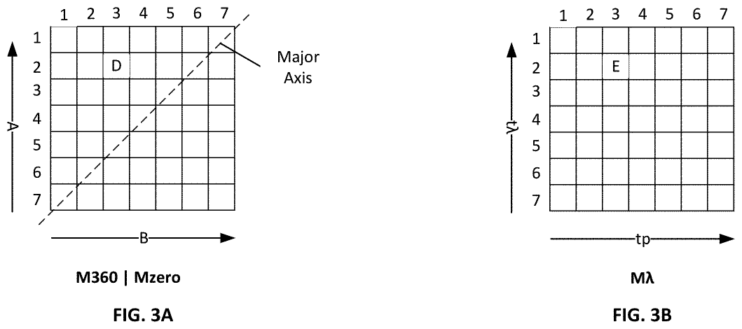

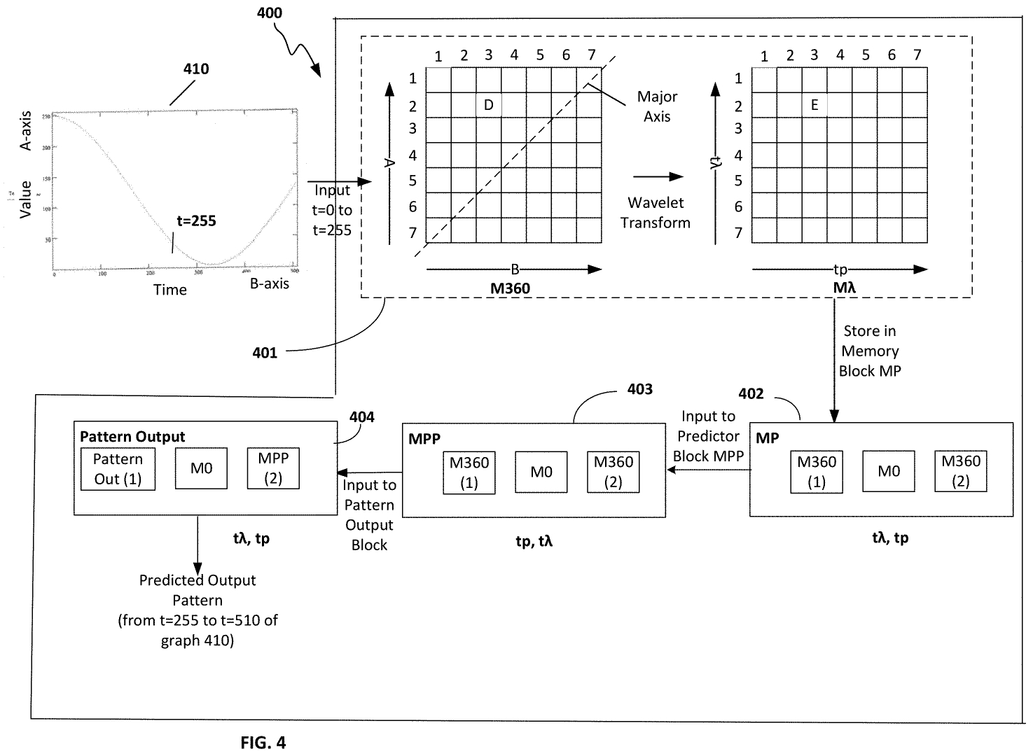

Referring now to FIGS. 3A-3B, a 360 degree symmetric matrix, M360 and an asymmetrical matrix, Mλ, are illustrated and will be used in the notation describing the matrix-based pattern prediction system. Consistent with a symmetric 360 degree matrix, the cell D in M360 is referenced by A and B, which can be mapped to an axis on matrix Mλ. When the second axis on matrix Mλ is also mapped from a second symmetric matrix, cell E is mapped in Mλ. Cell E in Mλ, in turn, is mapped to another matrix in the system. Note that all matrices used in the system are two-dimensional matrices. With the configuration of M360 and Mλ in mind, operation of the matrix-based pattern prediction system can be understood with reference to FIGS. 4-8(A) and 4-8(B).

FIG. 4 is a simplified schematic illustrating both components and operations of the matrix-based pattern prediction system 400 according to the present disclosure. As shown, the matrix-based pattern prediction system 400 generally comprises four components including a wavelet block 401, a memory block 402, a prediction block 403 and Pattern Output block 404.

The wavelet block 401 performs a matrix-based wavelet transform upon a time-based pattern, e.g. a semi-chaotic time-based pattern, and includes one 360 degree matrix matrix, M360 and one asymmetric matrix, Mλ. The size (e.g. the number of discrete values on each axis) of the symmetrical matrix M360 determine, in time units, both the number of time units (time units being, for example, seconds, minutes, days, years, etc.) of the input pattern and the maximum number of time units of the predicted output pattern. Mλ, while being asymmetric, consists of the same axis set as utilized in all matrices of the time-based pattern prediction system 400. The cells of matrix Mλ contain the matrix transform of the input pattern.

In the example of FIG. 4, the time-based pattern comprises a basic sine wave, however, any non-random, time-based pattern or semi-chaotic time-based pattern can be inputted to wavelet block 401. The time-based non-random pattern is scaled to suit the size of the matrix M360. Further, it should be noted that while M360 and Mλ are illustrated as 7×7 matrices, any suitably sized matrices can be used, though an odd number provides the best result. For example, in certain embodiments, it has been found that 1023×1023 provides acceptable predictive results within the pattern prediction system 400. This due to the larger bandwidth of the equivalent band pass filter property of the predictive system.

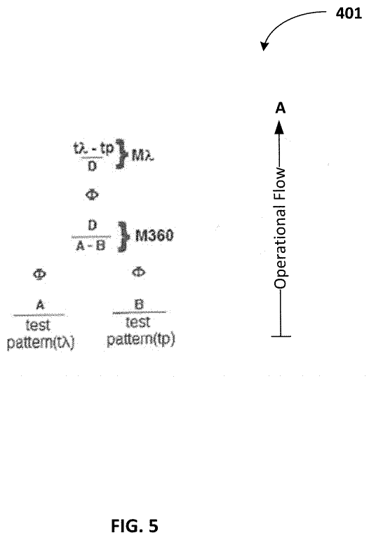

Notation representative of the operation of the wavelet block 401, e.g., how the time-based input pattern is converted into matrix-based wavelet transform, is illustrated in FIG. 5. Initially, the time-based input pattern is mapped to the axes of matrix M360(A,B) via the following mechanism:
a. The first axis A in matrix M360 maps the time-based input pattern in the sequence: 1, 2, 3, . . . to N, with N being the largest value on axis A of matrix M360. This is moving “right” and tA describes this operation.
b. The second axis B in matrix M360 maps the time-based input pattern in the sequence: N, N−1, N−2 to 1, with 1 being the smallest value on axis B of matrix M360. This is moving “left” and tp describes this operation.

A referenced cell (e.g., cell D) of matrix M360 is mapped to the to the axes of matrix Mλ(tλ,tp) by the following mechanism:
a. The first axis tλ in matrix Mλ cycles in the sequence 1, 2, 3, . . . to N, with N being the largest value on the axis of matrix M360. This is moving “right” and tλ describes this operation.
b. The second axis tp in matrix Mλ cycles in the sequence N, N−1, N−2, . . . to 1, with 1 being the smallest values on the axis of matrix M360. This is moving “left” and tp describes this operation.

Coefficients of wavelet transforms are placed in the symbolic matrix Mλ of FIG. 5, whereby the time-based input pattern is inputted to each axis (tp, tλ) by incrementing the time axis of the time-based input pattern by one symbol (tp) and mapping through all value time mappings of the input in the other axis (tλ). This process is repeated until all symbols (e.g., all cells) in Mλ have been mapped in both axes with the cells, e.g., cell D, of M360 mapped to a cell in matrix Mλ at each increment.

A wavelet is a zero-average function that is well localized in a small period of time to highlight different aspects of the pattern. A wavelet function, known as a mother wavelet, gives rise to a family of wavelets that are translated (shifted) and dilated (stretched or compressed) versions of the original mother wavelet. As such, the input can be represented as a summation of wavelets that are fundamentally identical except for the translation and dilation factors (or coefficients). Thus, the input signal can be represented entirely by wavelet coefficients that represent both time and frequency coefficients.

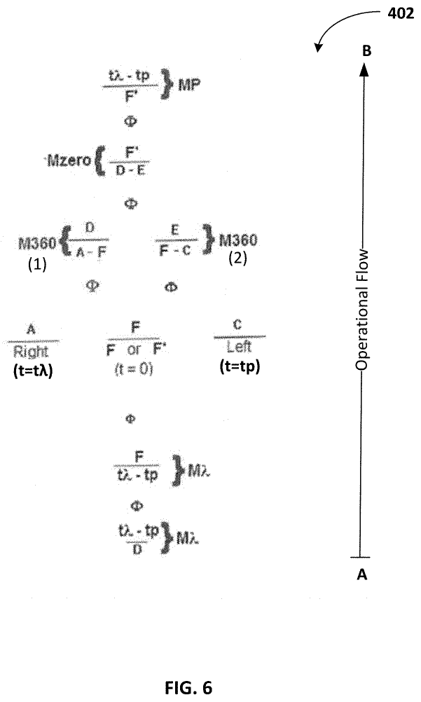

Continuing with the schematic of FIG. 4, the matrix Mλ is mapped to the memory block 402, also identified as MP. MP utilizes three matrices, a zero degree matrix, Mzero, and two 360 degree matrices, M360(1) and M360(2) to continuously feed input to matrix MP. Notation representative of how the wavelet transform of Mλ is stored in MP is illustrated in FIG. 6.

Referring to FIG. 6, The input wavelet transform comprises the asymmetrix matrix Mλ in which the cell D references both axes (tp, tλ). In transferring to MP, Mλ is flipped (e.g. (tλ,tp)), with the flipped matrix possessing the same content as the original Mλ the flipped matrix is also designated as Mλ. However, a cell in the flipped matrix Mλ is designated cell F to avoid confusion.

There are two possible patterns that can be input to the memory block MP. These two patterns comprise cell F and cell F′. In the instant case, cell F is chosen as the pattern input to MP. When the pattern to be stored equals the matrix size, the pattern input is gated closed and the memory output (cell F′) is gated open and used as the memory input to maintain the internal pattern via a closed loop

As such, the axis A in the matrix M360(1) maps cell F or cell F′ in the sequence 1, 2, 3, . . . to N, the largest value on the axis of matrix M360(1) (axis A). This is moving “Right;” tλ describes this operation. This operation is mapped to matrix M360(1) (cell A).

The referenced cell of M360(1) (D) is mapped to the axes of the matrix Mzero (cell D).

The axis C in matrix M360(2) maps cell F or cell F′ in the sequence: N, N−1, N−2, . . . to 1, the smallest vale on the axis of matrix M360(2) (axis C). This is moving “Left;” tp describes this operation. This operation is mapped to matrix M360(2) cell C.

The reference cell of M360(2) E is mapped to the axes of matrix Mzero cell E.

The cell of matrix Mzero (D,E) cell F′ is mapped to matrices M360(1) and M360(2) to maintain the pattern in the memory block and is the input cell, cell F′ of matrix MP.

Coefficients of matrix MP of FIG. 6 are placed therein, whereby the time-based pattern is inputted to each axis (tλ, tp), by incrementing the time axis of the time-based input pattern by one symbol (tλ) and mapping through all value time mappings of the input in the other axis (tp). This process is repeated until all symbols (e.g., all cells) in the matrix MP have been mapped in both axes with cell F′ mapped to a cell in matrix MP (tλ,tp) at each increment.

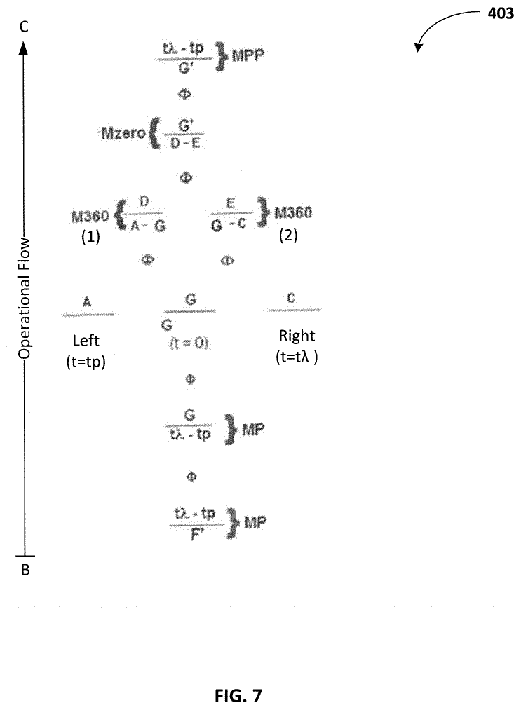

Continuing with the schematic of FIG. 4, the matrix MP is mapped to the predictor block 403, also identified as MPP. MPP utilizes three matrices, a zero degree matrix, Mzero, and two 360 degree matrices, M360(1) and M360(2) to feed input to matrix MPP. The predictive operation which generates the prediction matrix MPP is a form of matrix-based memory similar to the memory block MP. Notation representative of how a cell from matrix MP wavelet transform is mapped into the predictive block and the operation of the predictive block is illustrated in FIG. 7.

The input wavelet transform consists' of an asymmetric matrix MP, in which the cell “F′” references both axes. MP is flipped, with the flipped matrix possessing the same content as the original MP and so also designated MP. A cell in this second matrix MP is designated (cell G) to avoid confusion.

The difference between the wavelet axes (tλ, tp) used in in the matrix-based systems FIG. 5, FIG. 6 and the axes in the predictive operation, is that the sequence of “Left” and “Right” operations used is inverted (tp, tλ) for the generation of the predictive matrix MPP.

The axis A in matrix M360(1) maps (cell G) in the sequence: N, N−1, N−2 . . . to 1, the smallest value on the axis of matrix M360(1) (axis A). This is moving “Left”; tp describes this operation. This operation is mapped to matrix M360(1) (cell A).

The referenced cell of M360(1) (D) is mapped to the axes of matrix Mzero (cell D).

The axis C in matrix M360(2) maps (cell G) in the sequence: 1, 2, 3 . . . to N, the largest value on the axis of matrix M360(2) (axis C). This is moving “Right”; tλ describes this operation. This operation is mapped to matrix M360(2) (cell C).

The referenced cell of M360(2) (E) is mapped to the axes of matrix Mzero (cell E).

Coefficients of matrix MPP of FIG. 7, whereby the time-based input pattern is inputted to each axis (tλ, tp) by incrementing the time axis of the time-based input pattern by one symbol (tp) and mapping through all value time mappings of the input in the other axis (tλ). This process is repeated until all symbols (e.g. all cells) in MPP have been mapped in both axes with (cell G′) mapped to a cell in matrix MPP (tλ, tp) at each increment.

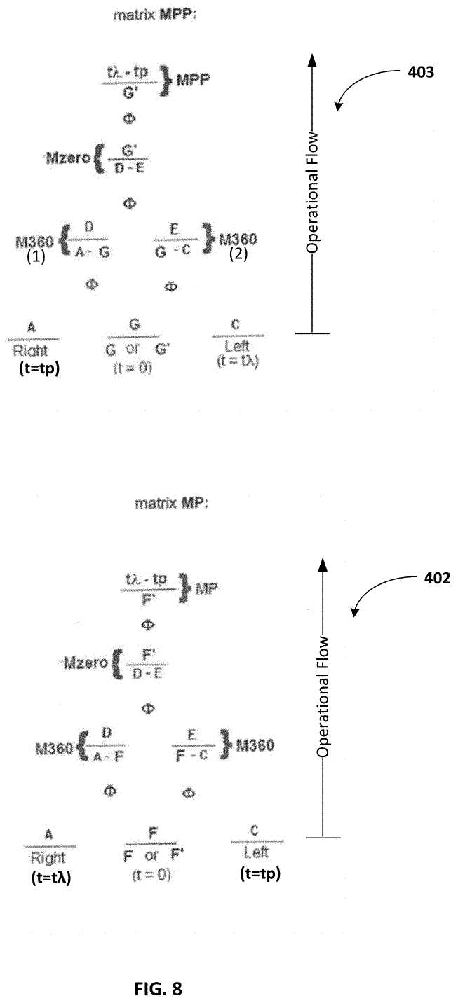

FIG. 8 provides a combination depiction of notation representative of the operation of the matrix-based memory block, MP, (also see FIG. 6) and matrix-based predictor block, MPP, (also see FIG. 7) to more clearly illustrate the flow of operations from block to block.

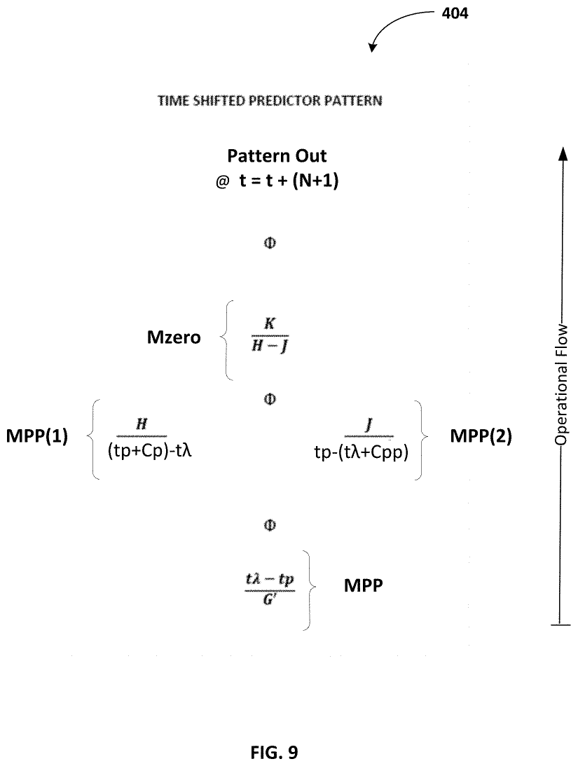

Referring once again to FIG. 4, the matrix MPP is mapped to the Pattern Output block 404, which is a wavelet/time conversion block. Notation representative of the how a cell from matrix MPP is mapped to the Pattern Output block and the operation of the Pattern Output block 404 is illustrated in FIG. 9.

The key difference between the wavelet axes (tλ, tp) used in in the matrix-based predictor block, MPP, of FIG. 7 and the axes used in the wavelet/time conversion Pattern Output block of FIG. 9, is that the sequence of “Right” and “Left” operations used is inverted to (tp, tλ), the original operation for the generation of the matrix.

This matrix-based wavelet/time transform of the Pattern Output block utilizes two MPP matrices, MPP(1) and MPP(2) and one zero degree matrix Mzero. The mapping to the axes of these matrices generates the conversion.

The input wavelet transform comprises asymmetric matrix MPP, in which the cell “G′” references both axis (tλ, tp). MPP is flipped, with the flipped matrix possessing the same content as the original MPP and so also designated MPP. The axes are also swapped to (tp, tλ).

The first matrix MPP (1) maps to axis H in matrix Mzero, in the sequence: N, N−1 . . . to 1, the smallest value on the axis of matrix MPP (1). This is moving “Left”; tp describes this operation.

The second matrix MPP (2) maps to axis J in matrix Mzero in the sequence:

1, 2 . . . to N, the largest value on the axis of matrix MPP (2). This is moving “Right”; tλ describes this operation.

The referenced cell of Mzero (cell K) is mapped to the time axis of PatternOut starting at time t=N+1.

In certain embodiments, to improve the predictive accuracy of the matrix-based pattern prediction system of the present disclosure, two variables can be introduced into the operation of the system. FIG. 9, depicting operation of the Pattern Output block (which is described above), also includes notation representative of the use of the variables Cp, Cpp. To improve predictive accuracy, the Pattern Output block generally performs three operations. The first operation is to automatically perform a DC offset so that the Pattern Out output is aligned with the end of the original input pattern. This is a simple alignment operation and is not shown. The second operation is to add tilt, Cp, to this automatic DC offset, starting at time N, where N is the matrix size; this is shown in the matrix MPP(1). Note that tilt, Cp, is used to compensate for low frequency (DC) components present in the original semi-chaotic input pattern. The third operation is to add a time shift, Cpp, which is shown in matrix MPP(2). The variable Cpp is used to compensate for high frequency components present in the original semi-chaotic input pattern.

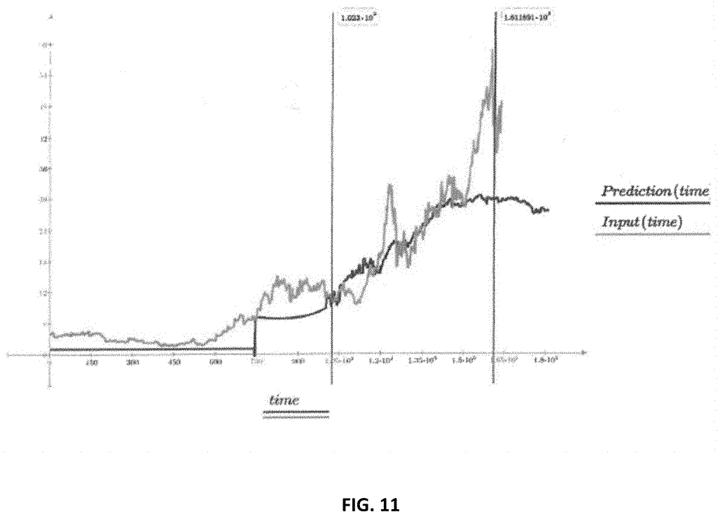

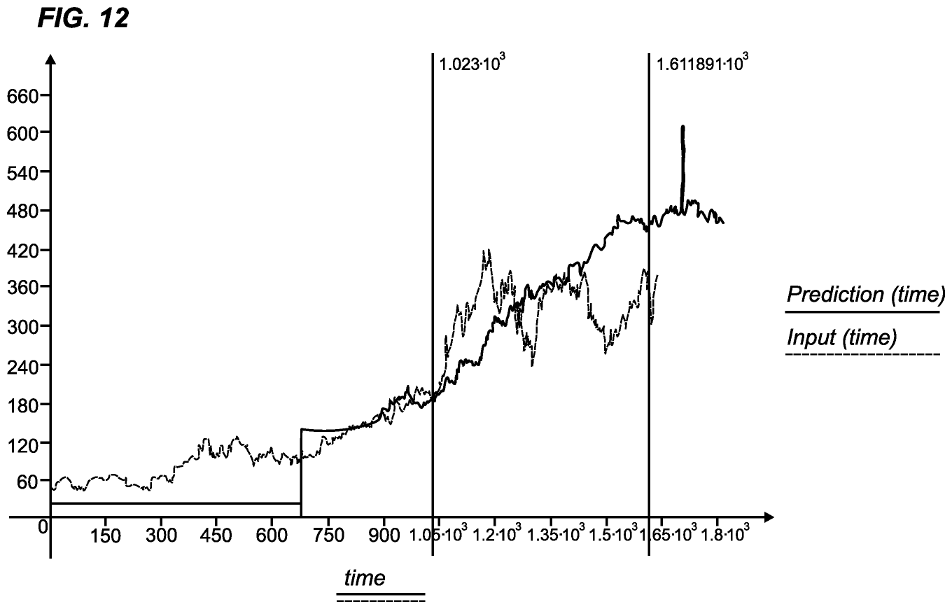

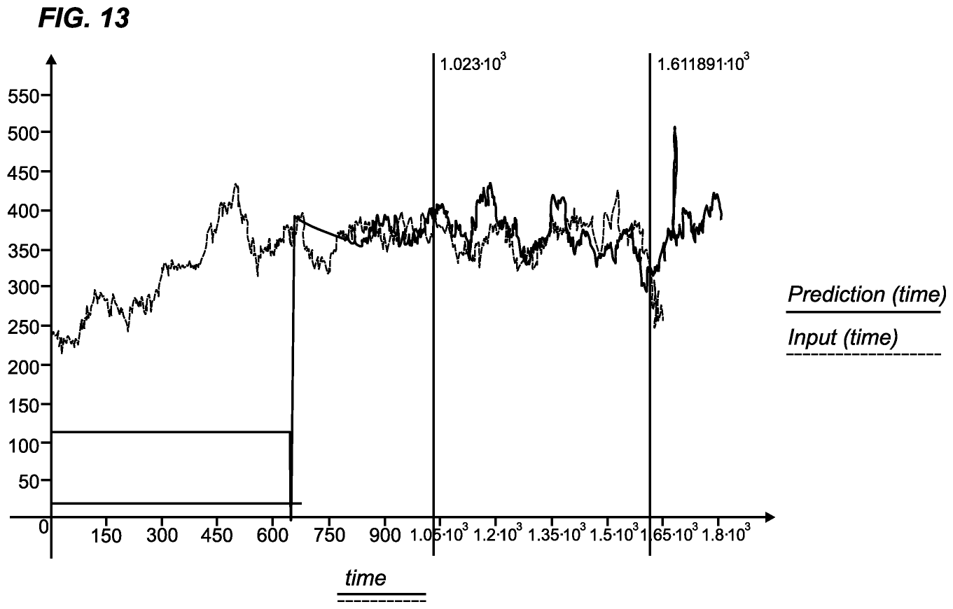

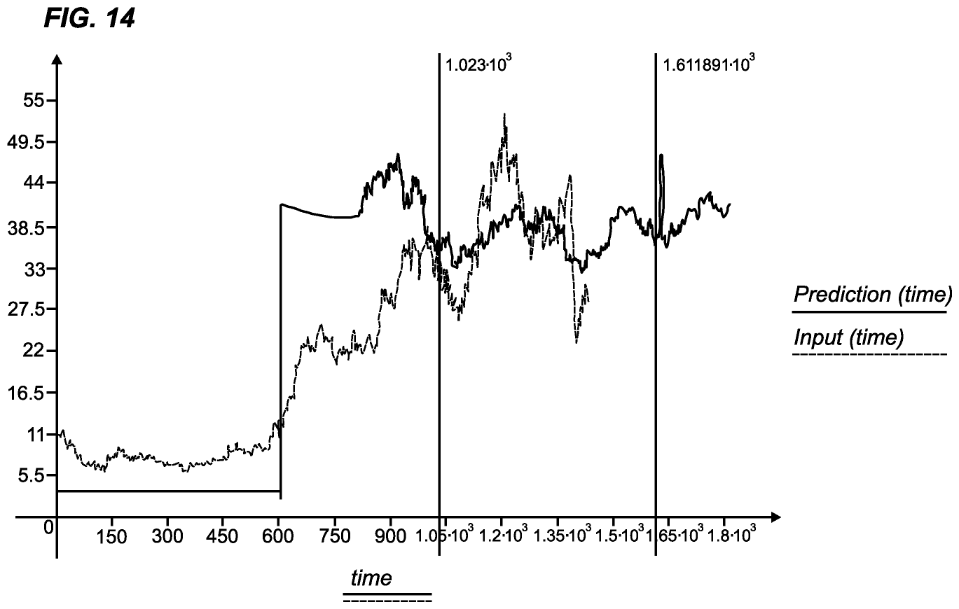

When compensating for frequencies outside the band pass range of the matrix-based pattern prediction system the following steps are taken:
1) All possible combinations of tilt (Cp) and time shift (Cpp) are generated, within a restricted range of time shift and tilt.
2) The time range was given as 300 time units for matrices of size 1023 (reference FIG. 11 to FIG. 14) or roughly ⅓ of available time units. This range can be greater or less depending on the desired accuracy and calculating resources.
3) For the inputted pattern, the time range is then from 723 to 1023, with 1023 being the last time unit of the inputted pattern.
4) For time shift (Cpp), the range is from 1023 to 723, with 1023 being the first time unit of the predicted pattern.
5) For tilt (Cp), the range is from 0 to 3. This range for tilt can be greater if needed to compensate for ramped DC components.
6) Generating all possible combinations of time shift and tilt produces two sets of nested matrices. Both sets are used for generation of Cp and Cpp
7) Cp and Cpp can be extracted from these nested matrices, based on the minimum area between the inputted pattern and the predicted pattern for a unique value of Cp and Cpp.
8) The combination of Cp and Cpp which generates the minimum area is used as variables in the pattern out block Pattern Out for the frequency compensation.

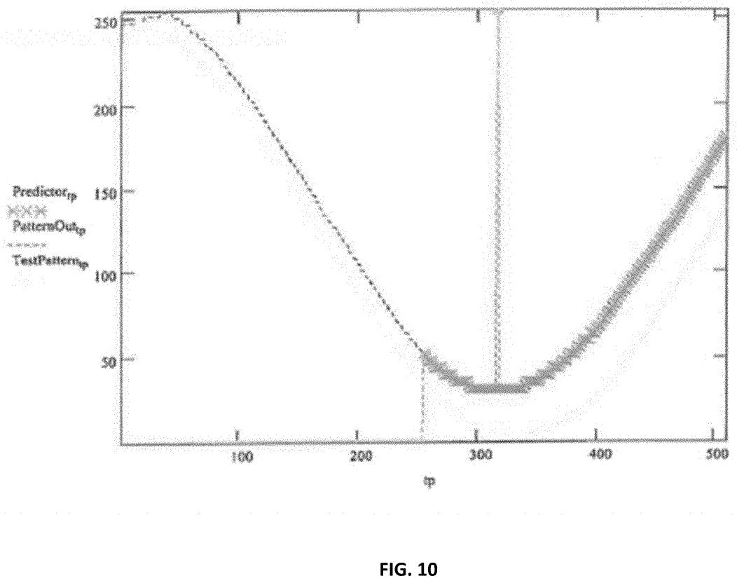

FIG. 10 is a comparison plot illustrating the input pattern of FIG. 4, e.g. “TestPatternₜₚ,” along with the output, e.g., “PatternOutₜₚ,” of a system operating only with standard memory block MP and the output, e.g., “Predictorₜₚ,” of the matrix-based pattern prediction system 400 with predictor block MPP. Note that the TestPatternₜₚ is the actual test pattern generated with time (tp=0, tp=500), the test pattern inputted to the matrix-based pattern prediction system is from time (tp=0, tp=255). and Predictorₜₚ is the predicted pattern of what the test pattern will be from time (tp=255, tp=500). Note that FIG. 10 Illustrates an inputted pattern consisting of a single frequency which is within the band pass of the matrix-based pattern prediction system meaning no compensation (e.g. no use of Cp or Cpp) is needed.

FIGS. 11-14 illustrate examples of predictions made by the matrix-based pattern prediction system 400 of the present disclosure. More particularly, each of the FIGS. 11-14 represent a time-based, semi-chaotic input pattern based on the commodities market that is to be input to the matrix-based pattern prediction system 400. The input pattern has been scaled to up to fill a 1023×1023 matrix M360 and, as such, the ending time unit is 1023. Each of FIGS. 11-14 illustrate the full inputted pattern from time unit zero to the maximum pattern run of up to ^{˜}1650 units in comparison to the prediction of the pattern by the matrix-based pattern prediction system 400 beginning at time unit N+1, e.g. time unit 1023, out to a maximum time unit of N*2, e.g. 2046 time units (the prediction has the 1023×1023 scaling removed to show actual commodity values).

It will be clear that the present invention is well adapted to attain the ends and advantages mentioned as well as those inherent therein. While a presently preferred embodiment has been described for purposes of this disclosure, various changes and modifications may be made which are well within the scope of the present invention. For example, other matrices exhibiting symmetry may be employed. Additionally, other asymmetric matrices may also be employed. Furthermore, additional learning algorithms may also be employed. Numerous other changes may be made which will readily suggest themselves to those skilled in the art and which are encompassed in the invention disclosed and as defined in the appended claims.

What is claimed:

1. A system for predicting an output pattern based on a semi-chaotic time-based input, the system comprising:
a matrix-based wavelet conversion block that receives the semi-chaotic time-based input, the matrix-based wavelet conversion block transforming the semi-chaotic input into a plurality of wavelets, each of the plurality of wavelets being associated with a coefficient, each of the coefficients being mapped to a first asymmetric matrix having first and second axes (tp, tλ);
a matrix-based memory block that maps the coefficients of the first asymmetric matrix to a second asymmetric matrix having flipped first and second axes (tλ, tp);
a matrix-based predictor block that maps the coefficients of the second asymmetric matrix to a third asymmetric matrix in a time-shifted configuration; and
a matrix-based pattern output block that transforms the coefficients of the third asymmetric matrix into a time-based output pattern that is a predictive of the semi-chaotic time-based input at a future time.

2. The system of claim 1, wherein the coefficients of the wavelets are representative of both time and frequency.

3. The system of claim 1, wherein the matrix-based wavelet conversion block includes a symmetrical 360 degree matrix and an asymmetric matrix.

4. The system of claim 3, wherein the matrix-based wavelet conversion block scales the semi-chaotic time-based input to the size of the symmetrical 360 degree matrix.

5. The system of claim 1, wherein the mapping to the second asymmetric matrix of the matrix-based memory block is performed through use of three matrices including two 360 symmetric matrices and one zero degree matrix.

6. The system of claim 1, wherein the mapping to the third asymmetric matrix of matrix-based predictor block is performed through use of three-matrices including two 360 symmetric matrices and one zero degree matrix.

7. The system of claim 1, wherein the time-shifted configuration of the coefficients is representative of time-shifting the plurality of wavelets.

8. The system of claim 1, wherein the matrix-based memory block utilizes a first variable and the matrix-based predictor block utilizes a second variable, the first and second variables used to adjust time-shifting of the coefficients.

9. The system of claim 8, wherein the first and second variable are adjusted to maintain a minimum error between the coefficients stored in the matrix-based memory block and the coefficients stored in the matrix-based predictor block.

10. A method for predicting an output pattern based on a semi-chaotic time-based input the method comprising:
transforming the semi-chaotic time-based input into a plurality of wavelets, each of the plurality of wavelets associated with a coefficient and mapping the coefficients of the plurality of wavelets to a first asymmetric matrix having a first axis (tp) and a second axis (tλ);
mapping the coefficients of the plurality of wavelets to a second asymmetric matrix having a first axis (tλ) and a second axis (tp), wherein two 360° matrices and a zero degree matrix are used to effect the mapping;
mapping the coefficients of the second asymmetric matrix to a third asymmetric matrix having a first axis (tp) and a second axis (tλ), wherein two 360° matrices and a zero degree matrix are used to effect the mapping in conjunction with a time-shift; and
transforming the time-shifted coefficients into a time-based output pattern that is a predictive of the semi-chaotic time-based input at a future time.

11. The method of claim 10, wherein the coefficients of the wavelets are representative of both time and frequency.

12. The method of claim 10, wherein transforming the time-based semi-chaotic pattern includes scaling the time-based semi-chaotic pattern to fit a number cells contained in a predetermined two-dimensional symmetric 360° matrix and storing the scaled pattern in the predetermined two-dimensional symmetric 360° matrix.

13. The method of claim 12, wherein transforming the time-based semi-chaotic pattern additionally includes mapping the cells of the predetermined two-dimensional symmetric 360° matrix to a two-dimensional asymmetric matrix, the mapping of cells including inputting the time-based pattern to each of two axes of the two-dimensional asymmetric matrix by incrementing one of the axes by one symbol and mapping through all value time mapping of the input in the second of the axes.

14. The method of claim 10, wherein a first variable is used to effect a first time-shaft at the second asymmetric matrix and wherein a second variable is used to effect the time-shift at the third asymmetric matrix.

15. The method of claim 14, wherein the first and second variables are adjusted to maintain a minimum error between the coefficients stored in second asymmetric matrix and the coefficients stored in the third asymmetric matrix.
